(19) United States
(12) Patent Application Publication
(10) Pub. No.: US 2008/0220803 A1
(43) Pub. Date: Sep. 11, 2008

(54) CONTROL OF SIGNAL TRANSMISSION POWER ADJUSTMENT REQUESTS

(75) Inventors: JOO HYUNG LEE, SEOUL (KR); JAE OH KIM, SEOUL (KR); JUNG TAE KIM, SEOUL (KR)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/682,414

(22) Filed: Mar. 6, 2007

(51) Int. Cl. H04Q 7/20

(52) U.S. Cl. 455/522

(57) ABSTRACT

A method of controlling an electronic device (100) to request changes in the transmission power of a received signal received by the electronic device; the method comprising obtaining a received signal strength parameter value for the received signal (425); transmitting a request for an increase in transmission power (460) in response to the received signal strength parameter value being within a lower signal strength parameter value range (455Y); transmitting a request for a decrease in transmission power (445) in response to the determined received signal strength parameter value being within an upper signal strength parameter value range (440Y); determining an accumulated signal strength parameter value for the received signal over an accumulation period (405); and adjusting the lower signal strength parameter value range or the upper signal strength parameter value range dependent on the accumulated signal strength parameter value (410, 415).

### FIELD OF THE INVENTION

The present invention relates to controlling signal transmission power in a wireless communications system, for example a transmitting device and a receiving device both operating according to a Bluetooth™ standard.

### BACKGROUND

Some paired transmitter and receiver radio communications systems can adaptively control the level at which a signal is transmitted by the transmitter depending on the level at which the signal is received by the receiver. The level of attenuation, interference and distortion of the signal over the air interface or channel varies due to the physical environment as well as the operation of other radio communications systems, and is typically not easy to predict. Adaptive transmission power control systems therefore typically use feedback from the receiver to the transmitter in the form of power control messages requesting an increase or decrease in the transmission power. An example of a short range communications system which uses this type of adaptive transmission power control is Bluetooth™.

Bluetooth™ communications system consume a small amount of power and are therefore suitable for small portable devices such as mobile phones and digital audio devices. Bluetooth™ specifications define a power control link manager protocol (LMP) message together with a receiver signal strength indicator (RSSI) measurement or value for instructing the transmitter to increase or decrease the signal transmission power. A Bluetooth™ receiver transmits an LMP message to a Bluetooth™ transmitter when the signal strength (RSSI) value of the signal received from the transmitter is between a RealLowerLimit and an RSSILowerLimit or between an RSSIUpperLimit and a RealUpperLimit. The RealLowerLimit is the minimum power level at which the receiver may receive a packet without failure, and the RealUpperLimit is the maximum power level at which the receiver may receive a packet without failure. When the received signal strength is between the RSSILowerLimit and the RSSIUpperLimit, no change of transmission signal power is required, however when the received signal strength falls below the RSSILowerLimit (but is above the RealLowerLimit), the receiver sends the transmitter an LMP message to increase transmission power. Similarly when the received signal strength rises above the RSSIUpperLimit (but is below the RealUpperLimit), the receiver sends the transmitter an LMP message to reduce transmission power. The transmitter receives the message and adjusts the signal transmission power accordingly. This usually results in the received signal strength (RSSI) then falling between the RSSIUpperLimit and the RSSILowerLimit as desired.

### SUMMARY

According to one aspect of the invention there is provided a method of controlling an electronic device to request changes in the transmission power of a received signal received by the electronic device. The method includes obtaining a received signal strength parameter value for the received signal; transmitting a request for an increase in transmission power in response to the received signal strength parameter value being within a lower signal strength parameter value range; transmitting a request for a decrease in transmission power in response to the received signal strength parameter value being within an upper signal strength parameter value range; determining an accumulated signal strength parameter value for the received signal over an accumulation period; and adjusting the lower signal strength parameter value range or the upper signal strength parameter value range dependent on the accumulated signal strength parameter value.

According to another aspect of the invention there is provided an electronic device for requesting changes in the transmission power of a signal received by the electronic device. The electronic device includes: a receiver for receiving the signal and arranged to obtain a received signal strength parameter value for the signal; a transmitter arranged to request an increase in transmission power in response to the received signal strength parameter value being within a lower signal strength parameter value range; the transmitter further arranged to request a decrease in transmission power in response to the received signal strength parameter value being within an upper signal strength parameter value range; the receiver further arranged to determine an accumulated signal strength parameter value for the signal over an accumulation period; and a processor arranged to adjust the lower signal strength parameter value range or the upper signal strength parameter value range dependent on the accumulated signal strength parameter value.

### BRIEF DESCRIPTION OF THE DRAWINGS

Embodiments will now be described with reference to the following drawings, by way of example only and without intending to be limiting, in which:

FIG. 1 is a schematic of an electronic device suitable for use with the embodiments;

FIG. 2 is a flow diagram illustrating power control in an electronic device operating according to a known Bluetooth™ specification;

FIGS. 3A and 3B illustrate adjustment of the RSSILowerLimit and RSSIUpperLimit for a bad channel and a good channel respectively;

FIG. 4 is a flow diagram illustrating power control in an electronic device operating according to an embodiment; and

FIG. 5 is a schematic illustrating an electronic device according to an embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to requesting changes in the transmission power of a signal received by an electronic device. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a method or device that comprises a list of elements does not include only those elements but may include other elements not expressly listed or inherent to such a method or device. An element proceeded by “comprises . . . a” does not, without more constraints, preclude the existence of additional identical elements in the method or device that comprises the element. Also, throughout this specification the term “key” has the broad meaning of any key, button or actuator having a dedicated, variable or programmable function that is actuatable by a user.

It will be appreciated that embodiments of the invention described herein may be comprised of one or more conventional processors and unique stored program instructions that control the one or more processors to implement, in conjunction with certain non-processor circuits, some, most, or all of the functions of requesting changes in the transmission power of a signal received by an electronic device described herein. The non-processor circuits may include, but are not limited to, a radio receiver, a radio transmitter, signal drivers, clock circuits, power source circuits, and user input devices. As such, these functions may be interpreted as steps of a method for requesting changes in the transmission power of a signal received by an electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

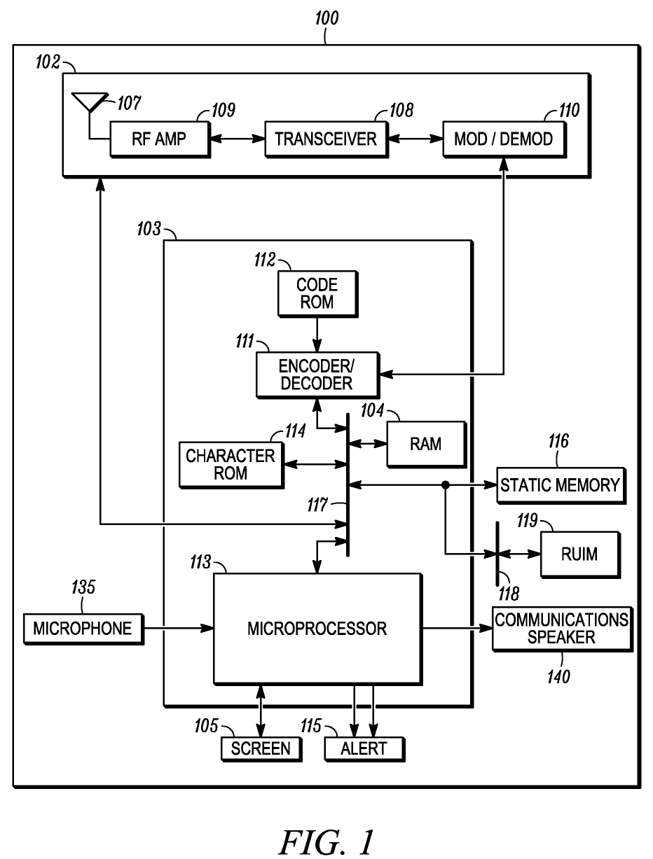

Referring to FIG. 1, there is a schematic diagram illustrating an electronic device 100, typically a wireless communications device, in the form of a mobile station or mobile telephone comprising a radio frequency communications unit 102 coupled to be in communication with a processor 103. The electronic device 100 also has a display screen 105. There is also an alert module 115 that typically contains an alert speaker, vibrator motor and associated drivers. The display screen 105, and alert module 115 are coupled to be in communication with the processor 103.

The processor 103 includes an encoder/decoder 111 with an associated code Read Only Memory (ROM) 112 for storing data for encoding and decoding voice or other signals that may be transmitted or received by the electronic device 100. The processor 103 also includes a micro-processor 113 coupled, by a common data and address bus 117, to the radio frequency communications unit 102, the encoder/decoder 111, a character Read Only Memory (ROM) 114, a Random Access Memory (RAM) 104, static programmable memory 116 and a Removable User Identity Module (RUIM) interface 118. The static programmable memory 116 and a RUIM card 119 (commonly referred to as a Subscriber Identity Module (SIM) card) operatively coupled to the RUIM interface 118 each can store, amongst other things, Preferred Roaming Lists (PRLs), subscriber authentication data, selected incoming text messages and a Telephone Number Database (TND phonebook) comprising a number field for telephone numbers and a name field for identifiers associated with one of the numbers in the name field. The RUIM card 119 and static memory 116 may also store passwords for allowing accessibility to password-protected functions on the mobile telephone 100.

The micro-processor 113 has ports for coupling to the display screen 105, and the alert module 115. Also, micro-processor 113 has ports for coupling to a microphone 135 and a communications speaker 140 that are integral with the device.

The character Read Only Memory 114 stores code for decoding or encoding text messages that may be received by the radio frequency communications unit 102. In this embodiment the character Read Only Memory 114, RUIM card 119, and static memory 116 may also store Operating Code (OC) for the micro-processor 113 and code for performing functions associated with the mobile telephone 100.

The radio frequency communications unit 102 is a combined receiver and transmitter having a common antenna 107. The radio frequency communications unit 102 has a transceiver 108 coupled to the common antenna 107 via a radio frequency amplifier 109. The transceiver 108 is also coupled to a combined modulator/demodulator 110 that couples the radio frequency communications unit 102 to the processor 103. The radio frequency communications unit 102 is suitable or arranged to operate according to a Bluetooth™ specification available as at the filing date of this application, such specifications being readily available to and well known by those skilled in the art.

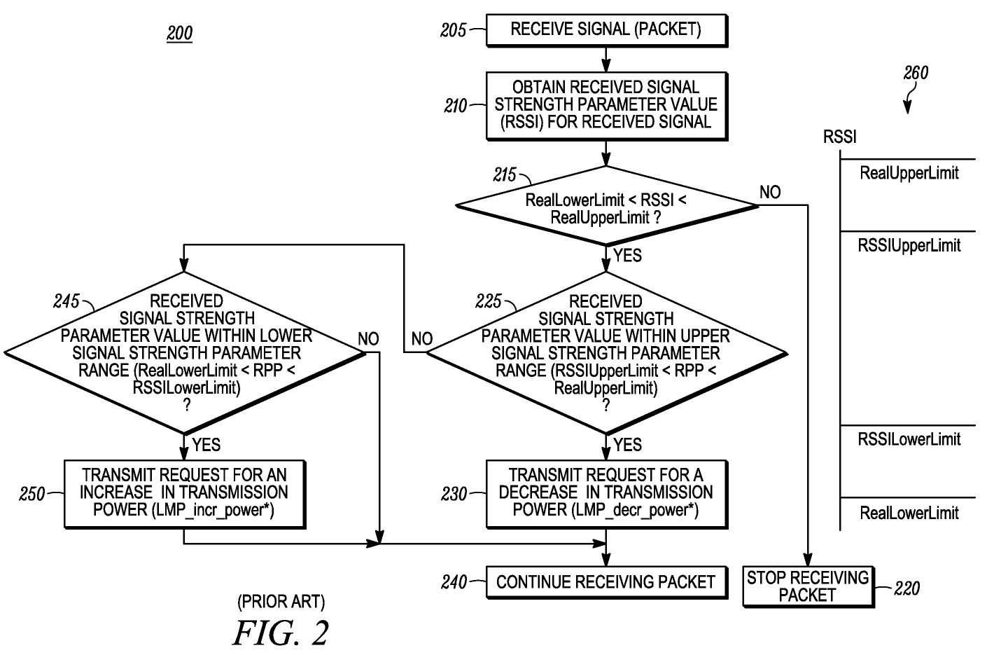

FIG. 2 illustrates a method of power control according to a known Bluetooth™ specification. The power control method 200 is implemented in an electronic device acting as a receiver which is receiving a signal from a transmitter such as a second electronic device. The (first) electronic device may also be acting as a transmitter in order to provide duplex communications. The method 200 receives a signal and in particular a signal burst or bursts associated with a packet as is known at step 205, and obtains a received signal strength parameter value such as an RSSI measurement for the received signal (packet or burst) at step 210. The method then determines whether the obtained received signal strength parameter (RSSI) value is within a range of RealLowerLimit to RealUpperLimit at step 215. This range is illustrated in the detail referenced 260. The electronic device operating according to the Bluetooth™ specification cannot receive a signal packet if the RSSI measurement is above the RealUpperLimit or below the RealLowerLimit as is known. If the obtained received signal strength parameter value is outside this range (215N), then the method stops receiving the signal packet at step 220, for example by not sending an acknowledgement message (ACK) associated with the packet to the transmitter.

If however the obtained received signal strength parameter value (RSSI) is within the allowed limits (215Y), then the method 200 determines whether the obtained received signal strength parameter (RSSI) value is within an upper signal strength parameter value range at step 225. The upper signal strength parameter value range comprises RSSI values or measurements between an upper limit (RealUpperLimit) and a lower limit (RSSIUpperLimit) of the upper signal strength parameter value range. Within this range, the received signal is stronger than required for successful reception, and therefore transmission power is being wasted and may also be interfering unnecessarily with other communications between other electronic devices. Therefore, in response to this condition (225Y), the method 200 transmits a request for a decrease in transmission power to the transmitter at step 230. This request is in the form of an LMP_decr_power_req_message message for devices operating according to one of the specifications for Bluetooth™. The method 200 then continues to receive the signal packet at step 240, as would be appreciated by those skilled in the art.

If the obtained received signal strength parameter (RSSI) value is not within an upper signal strength parameter value range (225N), then the method determines whether the obtained received signal strength parameter (RSSI) value is within a lower signal strength parameter value range at step 245. The lower signal strength parameter value range comprises RSSI values or measurements between a lower limit (RealLowerLimit) and an upper limit (RSSILowerLimit) of the lower signal strength parameter value range. Within this range, the received signal is approaching a value that is too low for successful reception, and therefore the receiving electronic device is in danger of dropping the (or a subsequent) signal packet, which would require re-transmission and hence waste bandwidth. Therefore, in response to this condition (245Y), the method 200 transmits a request for an increase in transmission power to the transmitter at step 250. This request is in the form of an LMP_incr_power_req_message message for devices operating according to one of the specifications for Bluetooth™. The method 200 then continues to receive the signal packet at step 240, as would be appreciated by those skilled in the art.

If the obtained received signal strength parameter (RSSI) value is not within a lower signal strength parameter value range (245N), this means that the signal strength of the received signal packet is between RSSIUpperLimit and RSSILowerLimit which requires no change to the transmission power. The method 200 then continues to receive the signal packet at step 240, as would be appreciated by those skilled in the art. The method may be repeated for each received packet or periodically

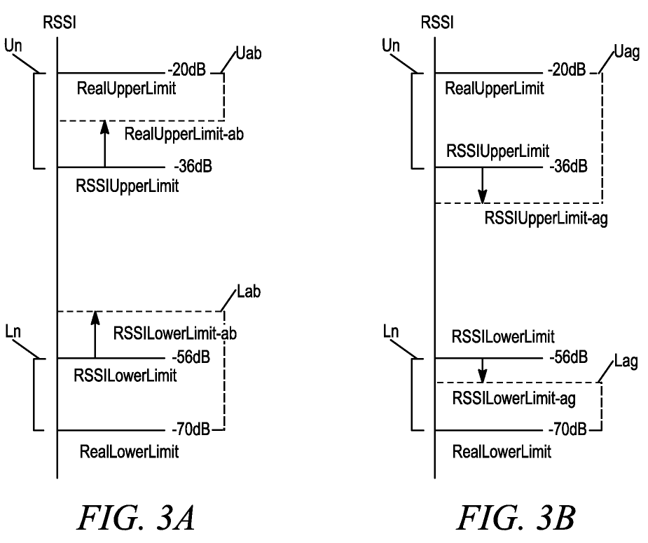

FIG. 3A illustrates a modification to this transmission power control method according to an embodiment. The lower limit of the upper signal strength parameter range (RSSIUpperLimit) and the upper limit of the lower signal strength parameter range (RSSILowerLimit) have been increased as shown to RSSIUpperLimit-ab and RSSILowerLimit-ab respectively. The effect of this is to increase the lower signal strength parameter value range, from Lₙ to L_{ab}, and to decrease the upper signal strength parameter range, from Uₙ to U_{ab}. Theses two ranges are adjusted or adapted for a bad channel such as an outdoors signal propagation environment which does not benefit from significant multi-path signal propagation and may suffer increased interference from other radio sources. A signal in a bad channel may suffer increased attenuation, fading and other signal propagation phenomena well known to those skilled in the art. The result of this is that the signal strength of the received signal will typically be less than an average received signal strength parameter value over all signal propagation environments, and may also vary significantly. The received signal may also suffer greater interference from other signals.

Therefore even if the received signal strength parameter value (e.g. RSSI) is above the upper limit of the lower signal strength parameter value range (RSSILowerLimit), a request to increase the transmission power may still be made when the signal is received over a bad channel in order to increase the signal-to-noise and/or inference ratios of the received signal. In addition an increased received signal strength parameter value, in response to the increased transmission power, will reduce the possibility of the received signal strength parameter suddenly dropping below RealLowerLimit due to sudden fading and hence a packet being dropped. Similarly the transmission power may not be reduced when the received signal strength parameter (RSSI) value is above the lower limit of the upper signal strength parameter value range (RSSIUpperLimit) set by Bluetooth™ when the signal is received over a bad channel. Requests to reduce transmission power may be delayed until the received signal strength parameter value is significantly above the RSSIUpperLimit in order to avoid unnecessarily reducing the received signal's signal to noise/interference ratio.

FIG. 3B illustrates modifying the transmission power control method for a good channel. The lower limit of the upper signal strength parameter value range (RSSIUpperLimit) and the upper limit of the lower signal strength parameter value range (RSSILowerLimit) have been decreased as shown to RSSIUpperLimit-ag and RSSILowerLimit-ag respectively. The effect of this is to decrease the lower signal strength parameter value range, from Lₙ to L_{ag}, and to increase the upper signal strength parameter range, from Uₙ to U_{ag}. Theses two ranges are adjusted or adapted for the good channel, such as an indoors signal propagation environment which benefits from significant multi-path signal propagation and reduced interference from other radio sources. A signal in a good channel may suffer less attenuation, fading and other signal propagation phenomena well known to those skilled in the art. The result of this is that the signal strength of the received signal will typically be greater than an average received signal parameter value over all signal propagation environments, and is less likely to vary significantly. The received signal will also typically suffer less interference from other signals.

Therefore even if the received signal strength parameter (e.g. RSSI) value is just below the RSSILowerLimit, a request to increase the transmission power may not be required when the signal is received over a good channel as the signal-to-noise and/or inference ratios of the received signal will typically still be adequate. Similarly over a good channel, there is a reduced possibility of the received signal strength parameter suddenly dropping below RealLowerLimit due to sudden fading, and hence a packet being dropped. Similarly the transmission power may be reduced when the received signal strength parameter (RSSI) is below the Bluetooth™ set RSSIUpperLimit when the signal is received over a good channel. Requests to reduce transmission power may then be made when the received signal strength parameter value is at a level below the RSSIUpperLimit in order to reduce power consumption by the transmitting device and reduce interference with other communicating devices.

In an embodiment, the quality of the propagation channel (good or bad) can be determined from an accumulated signal strength parameter value for the received signal over an accumulation period. This accumulated signal strength parameter value may be the signal power (P) integrated over the saturation time—a period which will be familiar to those skilled in the art. Alternatively the RSSI measurement may be integrated over this time. Other accumulation periods may alternatively be used, for example a duration corresponding to a predetermined number of received packets.

The lower signal strength parameter value range (Ln, Lab, Lag) and/or the upper signal strength parameter value range (Un, Uab, Uag) may then be adjusted dependent on this accumulated signal strength parameter value. A low signal power (P) is indicative of a bad channel and the lower signal strength parameter value range is adjusted to increase the RSSILowerLimit and the upper signal strength parameter value range is adjusted to decrease the RSSIUpperLimit as shown in FIG. 3A. Conversely, a high signal power (P) is indicative of a good channel and the lower signal strength parameter value range is adjusted to reduce the RSSILowerLimit and the upper signal strength parameter value range is adjusted to increase the RSSIUpperLimit as shown in FIG. 3B.

In an embodiment, the gain setting G_{AGC} of an automatic gain controller (AGC) may be used as the accumulated signal strength parameter. Most receiving devices use an AGC, and the gain setting (G_{AGC}) may be used to derive a suitable RSSILowerLimit and RSSIUpperLimit, for example using a lookup table. Alternatively, the signal voltages in the receiver signal paths may be used to proxy the accumulated signal strength parameter value, for example using the following equations:

$${V}_{mean} = \frac{{\sum }_{k = 1}^{{U}_{k}} \sqrt{{( {y}_{k} )}^{2}}}{{U}_{k}} ( {U}_{k} = update interval )$$

where Yₖ=(Vᵢ²+V_{q}²)^{1/2}, Vi and Vq are the in-phase and quadrature phase signal path voltages respectively, and k is the number of packets in the update

$$\text{?}$$

$${G}_{AGC} \approx \sqrt{\frac{{P}_{mean}}{{P}_{standard}}}$$

$${α}_{AGC} = {G}_{AGC} \times c ( c = cont . )$$

$${RSSIUpperLimit}_{update} = RSSIUpperLimit \times {α}_{AGC}$$

$${RSSILowerLimit}_{update} = RSSILowerLimit \times {α}_{AGC}$$

$$\text{?} \text{indicates text missing or illegible when filed}$$

where Pmean is the mean signal power over the update period or interval, Pstandard is a predetermined signal power value from a Bluetooth™ specification, GAGC is the accumulated signal strength parameter value, c is an experimentally obtained constant, and α_{AGC} is an adjustment parameter for applying to the current RSSIUpperLimit and RSSILowerLimit.

Thus the lower signal strength parameter value range and the upper signal strength parameter range are adjusted dependent on the signal voltage (Vi and Vq) integrated over a plurality (k) of packets, the value of which is indicative of the accumulated signal strength of the received signal. RSSIUpperLimit_{update} corresponds to RSSIUpperLimit-ab in FIG. 3A for a bad channel, and RSSIUpperLimit-ag in FIG. 3B for a good channel. Similarly, RSSILowerLimit_{update} corresponds to RSSILowerLimit-ab in FIG. 3A for a bad channel, and RSSILowerLimit-ag in FIG. 3B for a good channel.

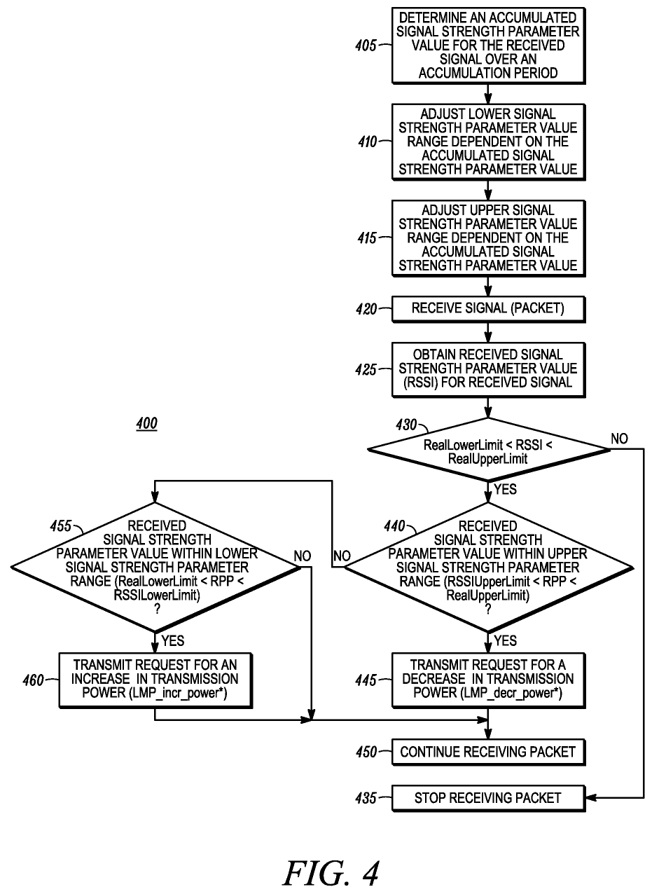

FIG. 4 illustrates a method of controlling an electronic device (100) to request changes in the transmission power of a signal received by the electronic device, and according to an embodiment. The method 400 is implemented in an electronic device acting as a receiver which is receiving a signal from a transmitter. The electronic device may also be acting as a transmitter in order to provide duplex communications. The method 400 determines an accumulated signal strength parameter value for the received signal over an accumulation period at step 405. As discussed above, this may simply involve obtaining a current gain setting G_{AGC} from an automatic gain controller (AGC) or from a stored value derived from this gain setting. Alternatively, the accumulated signal strength parameter value may be determined from a separate process which integrates received signal voltages over an accumulation period corresponding to a number of received packets, and which calculates an accumulated signal strength parameter value G_{AGC} according to the above equations.

The method 400 then adjusts the lower signal strength parameter value range (RealLowerLimit to RSSILowerLimit) dependent on the accumulated signal strength parameter value G_{AGC} at step 410. This may be implemented by determining RSSILowerLimit_{update} in the equations described above. In the embodiments illustrated in FIGS. 3A and 3B, this involves adjusting the upper limit of the lower signal strength parameter value range (RSSILowerLimit) dependent on the accumulated signal strength parameter value—lower for a good channel (high G_{AGC}) and higher for a bad channel (low G_{AGC}). The method 400 then adjusts the upper signal strength parameter value range (RealUpperLimit to RSSIUpperLimit) dependent on the accumulated signal strength parameter value G_{AGC} at step 415. This may be implemented by determining RSSIUpperLimit_{update} in the equations described above. In the embodiments illustrated in FIGS. 3A and 3B, this involves adjusting the lower limit of the upper signal strength parameter value range (RSSIUpperLimit) dependent on the accumulated signal strength parameter value—lower for a good channel (high G_{AGC}) and higher for a bad channel (low G_{AGC}). Whilst this embodiment shows adjusting both the lower and upper signal strength parameter values ranges, in alternative embodiments only one of these ranges may be adjusted.

The method 400 then corresponds to the method of FIG. 2, and receives a signal (packet) at step 420. The method then obtains a received signal strength parameter value such as an RSSI measurement for the received signal (packet) at step 425. The method 400 then determines whether the obtained received signal strength parameter (e.g. RSSI) value is inside a range of RealLowerLimit to RealUpperLimit at step 430. This range is illustrated in the detail referenced 260 in FIG. 2, and also in FIG. 3A and FIG. 3B. If the obtained signal strength parameter value (e.g. RSSI) falls outside this range (430N), then the method stops receiving the signal packet at step 435, for example by not sending an acknowledgement message associated with the packet to the transmitter.

If however the obtained received signal strength parameter value (RSSI) is within the allowed limits (430Y), then the method determines whether the obtained received signal strength parameter (RSSI) value is within the adjusted upper signal strength parameter value range at step 440. The adjusted upper signal strength parameter value range is between the RealUpperLimit and the increased or decreased RSSIUpperLimit_{update}—this is RSSIUpperLimit-ab in FIG. 3A for a bad channel, and RSSIUpperLimit-ag in FIG. 3B for a good channel. Within this range, the received signal is stronger than required for successful reception, given the channel conditions corresponding to the accumulated signal strength parameter value, and therefore is wasting transmission power and may also be interfering unnecessarily with other communications between other electronic devices. Therefore, in response to this condition (440Y), the method 400 transmits a request for a decrease in transmission power to the transmitter at step 445. This request is in the form of an LMP_decr_power_req_message message for devices operating according to one of the specifications for Bluetooth™. The method 400 then continues to receive the signal packet at step 450, as would be appreciated by those skilled in the art.

If the obtained received signal strength parameter (RSSI) value is not within the (adjusted) upper signal strength parameter value range (440N), then the method determines whether the obtained received signal strength parameter (RSSI) value is within the adjusted lower signal strength parameter value range at step 455. The (adjusted) lower signal strength parameter value range is between the RealLowerLimit and the increased or decreased RSSILowerLimit_{update}—this is RSSILowerLimit-ab in FIG. 3A for a bad channel, and RSSILowerLimit-ag in FIG. 3B for a good channel. Within this range, the received signal is approaching a value that is too low for successful reception given the channel conditions implied by G_{AGC}, and therefore the receiving electronic device is in danger of dropping the signal packet, which would require re-transmission and hence waste bandwidth. Therefore, in response to this condition (455Y), the method 400 transmits a request for an increase in transmission power to the transmitter at step 460. This request is in the form of an LMP_incr_power_req_message message for devices operating according to one of the specifications for Bluetooth™. The method 400 then continues to receive the signal packet at step 440, as would be appreciated by those skilled in the art.

If the obtained received signal strength parameter (RSSI) value is not within the adjusted lower signal strength parameter value range (455N), this means that the signal strength of the received signal packet is between RSSIUpperLimit_{update} and RSSILowerLimit_{update} which requires no change to the transmission power. The method 400 then continues to receive the signal packet at step 440, as would be appreciated by those skilled in the art.

By adjusting the lower signal strength parameter value range and/or the upper signal strength parameter value range according to the channel conditions implied by the accumulated signal strength parameter value G_{AGC}, the method allows an electronic device acting as a receiver to request increases or decreases of transmission signal power at a transmitter in order to receive signals having received signal strength parameter values that are more appropriate to the channel conditions.

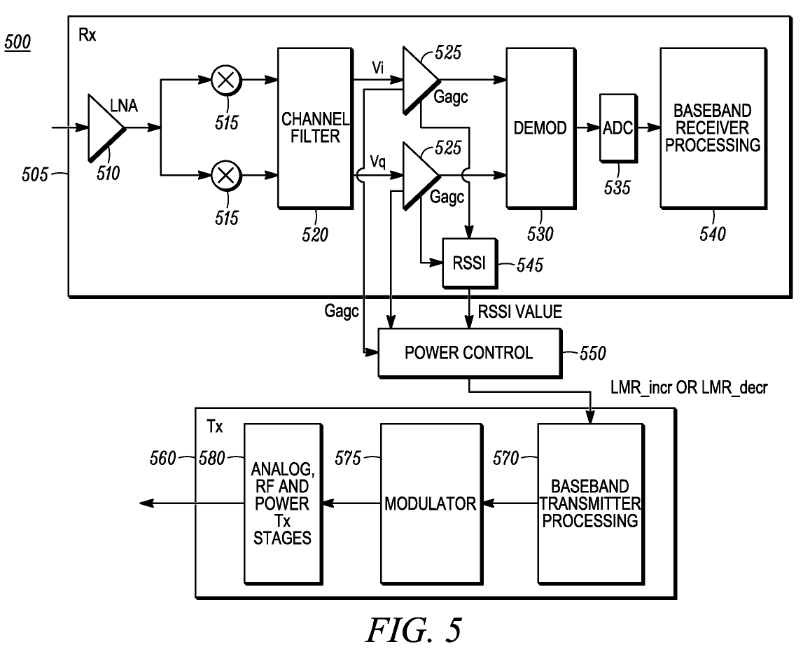

FIG. 5 illustrates an electronic device part according to an embodiment in more detail and including functional blocks relating to the receiver and transmitter functions associated with the method of FIG. 4. These functional blocks may be implemented by the radio frequency communications unit 102 and/or the processor 103 of the electronic device 100 of FIG. 1. The electronic device part 500 operates as a receiver according to a Bluetooth™ specification and comprises a receiver block 505 and a transmitter block 560. The receiver block comprises a low noise amplifier 510 from which in-phase and quadrature phase signal paths feed into respective in-phase and quadrature phase mixers 515. The mixers 515 mix the received in-phase and quadrature phase signal components with the channel frequency as is known. The receiver block 505 also comprises a channel filter 520, controllable in-phase and quadrature phase amplifiers 525, a demodulator 530, an analog-to-digital stage 535 and a baseband receiver processing stage for digital signal processing on the digitized received signals as is known. The controllable amplifiers 525 are implemented as automatic gain controllers (AGC) which are arranged to maintain their output signal level at an average level, for example amplifying weaker signal input at a higher gain. The input signal level at each AGC is determined and used to adjust the gain of the respective controllable amplifier 525 as is known. A received signal strength indicator (RSSI) module 545 determines an RSSI measurement for each received signal packet as is known. This is typically achieved by monitoring the signal inputs to the respective controllable amplifiers 525. The transmitter block 560 comprises a baseband transmitter processing block 570, a modulator 575, and analog-to-digital, radio frequency and power amplification stages 280, each of which will be well known to those skilled in the art. The electronic device part 500 also comprises a power control module 550.

The power control module implements the method of FIG. 4, and receives inputs from the RSSI module 545 and/or directly from the controllable amplifiers 525 (AGC amplifiers). Thus the power control module 550 receives an instantaneous RSSI measurement for a packet in the received signal from the RSSI module 545 corresponding to the received signal strength parameter value. These RSSI measurements may be integrated by the power control module 550 over the accumulation period in order to determine the accumulated signal strength parameter value. Alternatively this value may be determined by measuring the signal voltage levels (Vi and Vq) received by the controllable amplifiers 525 (AGC amplifiers) and performing the previously described calculations. As a further alternative, the gain setting (G_{AGC}) of the controllable amplifiers 525 may be used directly, averaging the respective in-phase and quadrature phase gain settings, the gain setting being dependent on the accumulated signal strength parameter value.

The accumulated signal strength parameter value (G_{AGC}) is then used to adjust the upper and/or lower signal strength parameter values ranges as previously described. When the instantaneous RSSI measurement falls within one of these adjusted ranges, the power control module 550 issues the appropriate power control message (LMP_decr_power_req_message or LMP_incr_power_req_message) to the baseband transmitter processing block 570. The power control message is then forwarded to the transmitter device via the rest of transmitter block 260 as is known. Upon receipt of this message by the transmitting device, the power of the transmission signal is adjusted so that the signal strength of the signal received by the receiving device (100, 500) is now more appropriate to the channel conditions (eg good or bad).

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

The skilled person will also appreciate that the various embodiments and specific features described with respect to them could be freely combined with the other embodiments or their specifically described features in general accordance with the above teaching. The skilled person will also recognise that various alterations and modifications can be made to specific examples described without departing from the scope of the appended claims.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of controlling an electronic device to request changes in the transmission power of a received signal received by the electronic device; the method comprising:
obtaining a received signal strength parameter value for the received signal;
transmitting a request for an increase in transmission power in response to the received signal strength parameter value being within a lower signal strength parameter value range;
transmitting a request for a decrease in transmission power in response to the received signal strength parameter value being within an upper signal strength parameter value range;
determining an accumulated signal strength parameter value for the received signal over an accumulation period; and
adjusting the lower signal strength parameter value range or the upper signal strength parameter value range dependent on the accumulated signal strength parameter value.

2. A method as claimed in claim 1, wherein adjusting the lower signal strength parameter value range comprises adjusting an upper limit of the lower signal strength parameter value range dependent on the accumulated signal strength parameter value, and wherein adjusting the upper signal strength parameter value range comprises adjusting a lower limit of the upper signal strength parameter value range dependent on the accumulated signal strength parameter value.

3. A method as claimed in claim 2, wherein the upper limit of the lower signal strength parameter value range is increased in response to a decrease in the accumulated signal strength parameter value and the lower limit of the upper signal strength parameter value range is decreased in response to an increase in the accumulated signal strength parameter value.

4. A method as claimed in claim 1, wherein the received signal strength parameter value is the received signal strength indicator for the received signal, and the accumulated signal strength parameter value is determined from the signal power accumulated over a saturation time.

5. A method as claimed in claim 4, wherein the signal power accumulated over a saturation time is determined from a gain setting on an automatic gain controller of the device.

6. A method as claimed in claim 2, wherein the request for an increase in the transmission power comprises a LMP_incr_power_req message, the request for a decrease in the transmission power comprises a LMP_decr_power_req message, the upper limit of the lower signal strength parameter value range comprises the RSSILowerLimit parameter, and the lower limit of the upper signal strength parameter value range comprises the RSSIUpperLimit parameter.

7. An electronic device for requesting changes in the transmission power of a signal received by the electronic device; the electronic device comprising:
a receiver for receiving the signal and arranged to obtain a received signal strength parameter value for the signal;
a transmitter arranged to request an increase in transmission power in response to the received signal strength parameter value being within a lower signal strength parameter value range;
the transmitter further arranged to request a decrease in transmission power in response to the received signal strength parameter value being within an upper signal strength parameter value range;
the receiver further arranged to determine an accumulated signal strength parameter value for the signal over an accumulation period; and
a processor arranged to adjust the lower signal strength parameter value range or the upper signal strength parameter value range dependent on the accumulated signal strength parameter value.

8. An electronic device as claimed in claim 7, wherein the receiver comprises an automatic gain controller having a gain setting dependent on the accumulated signal strength parameter, the processor arranged to adjust the lower signal strength parameter value range or the upper signal strength parameter value range dependent on the gain setting.
